(19) United States
(12) Patent Application Publication
(10) Pub. No.: US 2008/0015113 A1
(43) Pub. Date: Jan. 17, 2008

(54) METHOD FOR STORAGE OF GENE EXPRESSION RESULTS

(75) Inventors: Aaron H. Alpar, San Jose, CA (US); Jennifer Durham, Sunnyvale, CA (US)

Correspondence Address: HARNESS, DICKEY & PIERCE, P.L.C., P.O. BOX 828, BLOOMFIELD HILLS, MI, 48303, US

(73) Assignee: APPLERA CORPORATION, Foster City, CA (US)

(21) Appl. No.: 11/769,308

(22) Filed: Jun. 27, 2007

Related U.S. Application Data
(60) Provisional application No. 60/806,235, filed on Jun. 29, 2006.

(51) Int. Cl. C40B 30/02; G06F 17/30; G06F 7/06

(52) U.S. Cl. 506/8; 707/102; 707/2; 707/E17.003; 707/E17.046

(57) ABSTRACT

Methods for applying reverse-hash indexing to biological data. Large quantities of biological data, such as gene expression data, that contain multiple instances of similar and/or identical information are processed where like values are indexed together. Replication in storage and repeated analysis information indexed according to these methods increases performance and efficiency with respect to database query and record access.

### CROSS-REFERENCE TO RELATED APPLICATIONS

This application claims the benefit of U.S. Provisional Application No. 60/806,235 filed on Jun. 29, 2006, the disclosure of which is incorporated herein by reference.

All literature and similar materials cited in this application, including but not limited to, patents, patent applications, articles, books, treatises, and internet web pages, regardless of the format of such literature and similar materials, are expressly incorporated by reference in their entirety for any purpose. In the event that one or more of the incorporated literature and similar materials differs from or contradicts this application, including but not limited to defined terms, term usage, described techniques, or the like, this application controls.

### INTRODUCTION

Relational databases are frequently used in information storage. The relational storage model, based on records and fields, is generally understood and a widely deployed database technology throughout the world. While relational database may be flexible and ubiquitous, their shortcomings become apparent when dealing with large amounts of data for which the model is not well matched. In particular, the large amounts of information that arise during analysis of biological data, including for example gene-expression data, may prove to be problematic to store in relational database models.

### SUMMARY

The present teachings provide alternative storage strategies better suited to large amounts of data and further provide improved search capabilities when dealing with large amounts of biological data.

In one aspect, the present teachings provide a method for developing a reverse-hash index file for a corpus that may be used to store information relating to biological data and analysis. For example, a reverse-hash index may be created for gene-expression results obtained from a biological analysis using a microarray, microplate or micro fluidic card (e.g., TaqMan® Low Density Array; Applied Biosystems, Foster City, Calif., USA) in which multiple discrete elements or values of data are present. Each distinct value found in these results may be matched to a collection of one or more identifiers. These identifiers may further be constructed as a list and serve to locate a selected data value or type, such as an atomic unit, being indexed in the corpus of data. For example, data related to gene expression results may be contained in a corpus and represented by either source data files or databases. The methods of the present teachings can be used to generate lists of gene-expression results faster than B-Tree indexing commonly implemented in relational database approaches.

Additional embodiments are set forth in part in the description that follows, and in part will be apparent from the description, or may be learned by practice of the various embodiments described herein.

### DRAWINGS

The skilled artisan will understand that the drawings, described herein, are for illustration purposes only. The drawings are not intended to limit the scope of the present teachings in any way.

In the drawings:

FIG. 1 illustrates relational database based approaches using key referencing of data;

FIG. 2 illustrates an exemplary reverse hash index storage approach;

FIG. 3 illustrates benchmarking of a reverse hash index-based storage approach; and

FIG. 4 illustrates exemplary queries executed against a relational database and a reverse hash index database.

It is to be understood that both the foregoing general description and the following detailed description are exemplary and explanatory only and are intended to provide a further explanation of the various embodiments of the present teachings.

### DESCRIPTION OF SOME EMBODIMENTS

The following description of some embodiments is merely exemplary in nature and is in no way intended to limit the present teachings, applications, or uses. Although the present teachings will be discussed in some embodiments as relating to gene-expression data, such as data obtained from DNA microarrays or gene chips, such discussion should not be regarded as limiting the present teaching to only such applications.

The section headings and sub-headings used herein are for general organizational purposes only and are not to be construed as limiting the subject matter described in any way.

Exemplary aspects of the disclosure provide methods for storing data in a manner that is an alternative to a conventional relational database format. As will be described in greater detail herein, these methods convey certain benefits over relational database formats and do not suffer from various limitations resulting from implementing a relational database for storage of large amounts of biological data.

The present teachings may be applied to storage and analysis of gene expression data. For example, any the present methods may be used in analysis of results collected from well-based gene expression systems, including microarray gene expression systems and plate-based systems.

Each run of a gene expression assay can produce a document of collected data. The document produced may include a name, some characterization of the chemistry, protocol, and details regarding the purpose of the assay processed. The document may also contain data collected from the many wells on the gene expression plate or microarray.

The present teachings include methods and systems that are designed to be easily implemented by a document storage system such as Lucene (Apache Software Foundation, Forest Hill, Md., USA), where each Result is stored as a Lucene term and each plate is stored as a document.

The following terms are used herein:

A “plate” is typically a gene expression plate, and may include an assay.

A “plate run” refers to the collection of gene expression data from the chemistry assay or run on a plate, microarray, or gene expression system. The plate run information may have some descriptive information, supplied by the user, and analysis data related to results derived from the run.

A “well” refers to a physical well on a gene expression plate which may contain an assay.

A “well run” includes a numerical value related to the gene expression properties of the well, usually stored as a vector (an array of floating point values). Well run data is associated with plate run data.

A “well result” includes a single numerical value related to the run of a well, usually stored as a single floating point value that is part of the well run vector. Each well result includes part of the data collected from a plate run.

A “plate description” includes information that relates to the physical properties of the plate, and may include manufacturer, materials, and plate geometry.

“Well description” refers to information that relates the physical and chemical properties of the wells on the plate as delivered from the manufacturer. These may include well geometry (relative to the place), probe composition, and assay (as described in the plate description).

“Plate run description” describes all of the lab processing information. This information may include the date that the chemistry (with assay) was combined by the user for analysis.

“Well run description” describes all of the lab processing information for a particular well relative to a plate run description.

A “well result description” includes a vector of gene expression data.

“Well pair” refers to well description data associated with well result data.

“Well result pair” associates a well run with a well result.

“Plate pair” associates plate description data with plate run data.

“Term” is a well result value associated with a well pair. The same well result value in different well runs is considered a different term. Therefore, terms are represented as a pair of values; the first value stores the actual, observed, value, and the second value names the value within the result.

“Inverted hashing” stores statistics about terms in order to make term-based searches more efficient. This is because inverted hashing can list for a term the wells and plates for that term. This is the inverse of the normal relationship where plates list wells.

The present teachings can refer to plates, wells, and well results by an integer plate number, well number, and well result number respectively. The first plate added to an index may be numbered zero, and each subsequent plate added receives a number one greater than the previous.

An “integer” is a vector of bits that describes an integer or ordinal value (Z).

A “string” is a vector (or array) of alphanumeric characters. Each character is usually stored as a fixed sized 8 bits, 16 bit, or 32 bit value. Each String is preceded by a 8 or 16 bit integer value that describes its length.

A “floating point value” is a array of bits that describes an real value (R).

A “bit” is the smallest storable unit of information—usually stored as an on/off value (binary 1 or 0 value).

A “document store” is used to store plate and well information. Any store that allows reverse indexing or reverse hashing of integer values may be used. Document stores are usually used for storing textual documents such as web pages. In order to facilitate fast search and retrieval, documents added to the store may have terms indexed according to what users will be likely to search. Each type of document for a given document store may have differing rules about how the search terms will be identified and stored.

For example, a typical HTML web page document storage system may look for strings of text separated by punctuation or spaces. These may be identified as words—if the words are found in an on-line English dictionary then they may be indexed for fast searching. This assumes that users will be searching using English words for search terms. Most document storage systems also have a facility for identifying the position that a particular term (or word) appears within the source document. Using the HTML example, when performing a keyword search, a user may want to see the all the found search terms highlighted in the source document. Storing the location of all the indexed terms (or words) will allow the system to present the original documents with the found search terms identified as highlighted text (in situ). Using a document system for storage and indexing of gene expression results is similar to storing HTML documents in a document storage system, but the system for identifying terms and what should be indexed is entirely different.

When storing gene expression results in a document store, each gene-expression plate result will be stored as a separate document in the same storage system. Each item of information that is of interest for analysis must be indexed in the corpus as a search term for the document. This may include manufacturing information, barcode information (for the plate of the run), and plate geometry, and well layout. Each well value may be stored as a term to be indexed in the document storage system with a reference to that well's position within the plate result (or document).

A “term dictionary” contains the terms used in the indexed fields of all of the documents. The dictionary also contains the number of documents which contain the term and pointers to the term's frequency and proximity data.

“Term vectors” include term text and term frequency. For each field in each document, the term vector (sometimes called document vector) may be stored.

In some embodiments, the present teachings store and retrieve well results from plate runs. Enough descriptive information may be stored in the system to locate well results from plate runs. Well result and plate run data may be stored using three different values, including strings, integers, and floating point values.

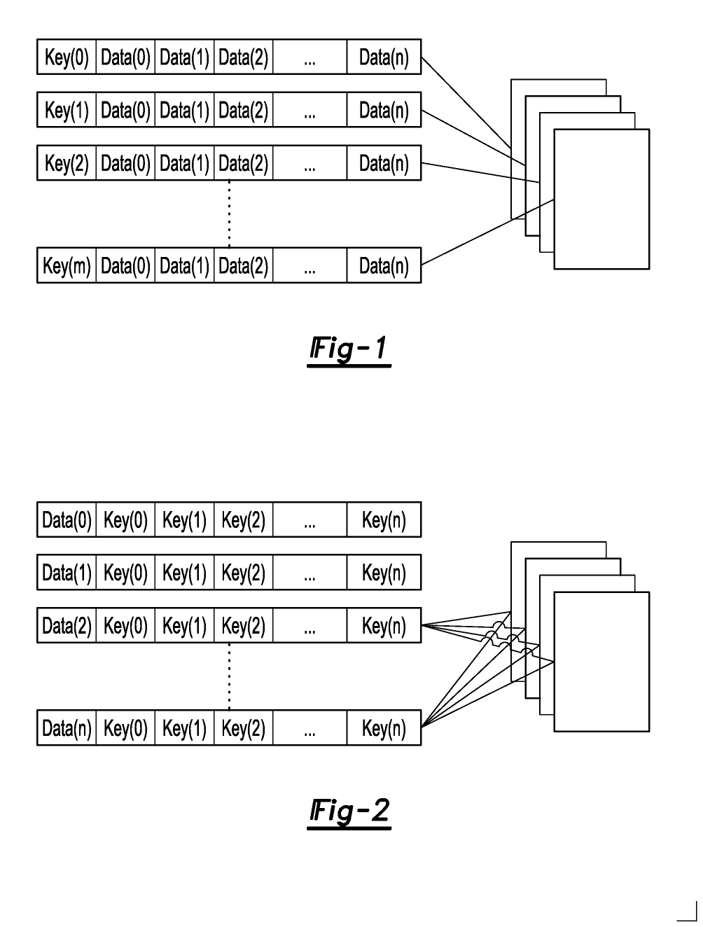

To better understand why gene-expression data is not well suited for storage in a relational database, it is helpful to understand the characteristics of the underling data. As shown in FIG. 1, in some respects, relational databases have been implemented to provide access to data by key referencing. For example, a key may be used to search for a selected record from within a collection of multiple records. Biological data, however, is not always well served through implementation of a key-based relational search.

For biological data, it may be the case that information is replicated many times over, or at least a portion of the data represents a sub-component of a search target. In the instance where gene-expression results are stored in a relational database, the storage for all the individual instances of these repeated values are typically replicated. These values are frequently keyed with geographical information (i.e., locality information). For example, data arising from a biological assay obtained from the analysis using a multi-well plate or microarray may be associated with geographical information relating to where the assay was located on the multiwell plate or microarray. Analysis results may be identified and accessed using this assay geography associated with the particular plate or array.

According to various embodiments of the present teachings, this information may be stored in an alternative manner using a reverse hash index. As shown in FIG. 2; the reverse hash index stores like values together. One desirable feature of this storage approach is that replication of data is reduced and the amount of space in storage consumed by the repeated information is reduced. In one aspect, results may be retrieved from the reverse hash index and related results acquired in an efficient manner. For example, biological data associated with one or more amplification reactions, such as generated during real-time PCR analysis, may be identified by threshold cycle (Ct) value or by probe/primer composition.

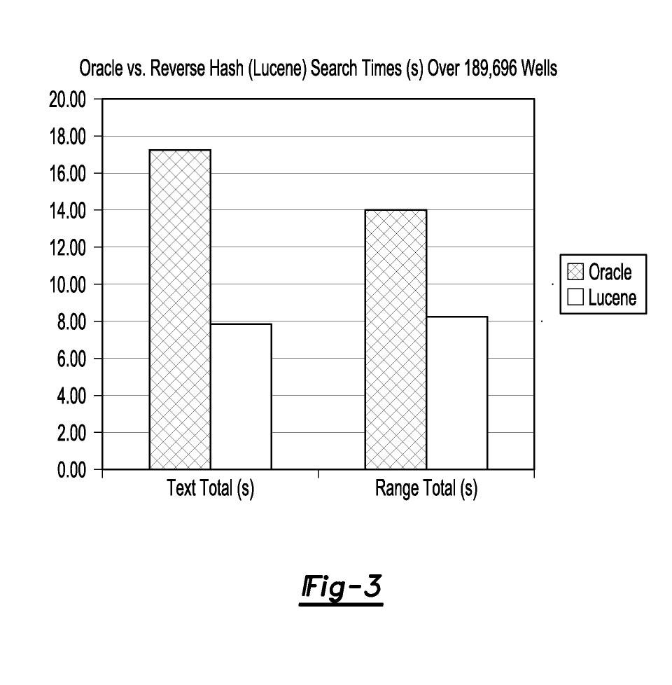

As shown in FIG. 3 benchmarking of a reverse hash index-based storage approach versus a conventional relational database indicates performance gains may be readily obtained using the reverse hash index. FIG. 3 depicts the performance results obtained when evaluating a conventional relational database storage approach (implemented using an Oracle database; Oracle Corporation, Redwood Shores, Calif., USA) versus a reverse hash index based storage approach using a corpus (implemented using Lucene; The Apache Software Foundation, Forest Hill, Md., USA). Queries against both the relational database and the corpus were performed against the same set of exemplary gene expression data containing approximately 190,000 records.

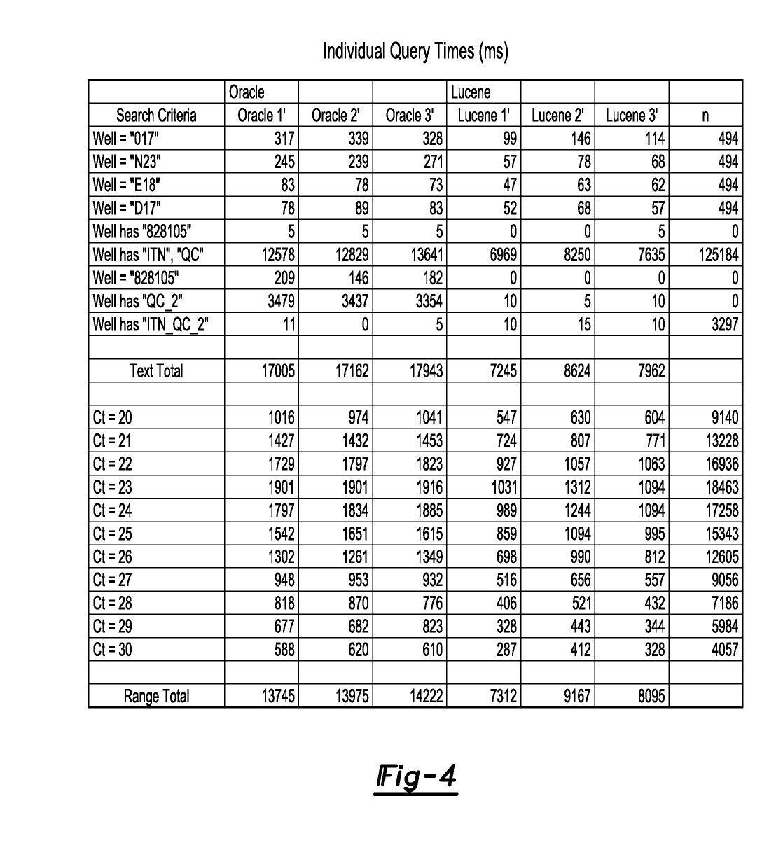

As shown in FIG. 4, courses of 10 queries were executed against each database with each query classified as a Keyword Search or a Range Search. For the relational database, B-Tree indexes were created for all columns being queried. For the corpus, reverse-hash indexes were created for each value.

Referring again to FIG. 3, based on a search of the approximately 190,000 records associated with wells of a microplate, search times can be significantly reduced for textual data and numerical data alike. In the illustration, search times may be reduced approximately in half or more depending on the nature of the query, the type of data being searched, and the number of records in the data set.

The aforementioned discussion provides an outline of an approach for storage of biological data including gene-expression data within a reverse-hash document corpus search and retrieval system.

Conventional informational query systems associated with searching large, textual, document corpuses such as those for Internet search engines and informational databases have been described elsewhere. For example, U.S. Pat. No. 5,920,854 assigned to Infoseek Corporation and U.S. Pat. No. 6,928,428 each provides search systems responsive to a user queries against a collection of documents. These systems, however, fail to provide a search and retrieval system that utilizes a reverse hash indexing approach that has been adapted for use with biological data stored in a corpus in the manner described by the present teachings. Implementation of the reverse hash indexing approach may be accomplished using commercially available software development tools, as well as public domain and open-source alternatives. These products may be adapted for use with the method for storage and retrieval of documents within a document corpus and further adapted for use in storing and querying biological data by following the practices set forth by the present teachings. Products that may be used to implement the reverse hash indexing method of the present teachings include Lucene, an open source Java based indexer, and Verity™, a commercial document indexer (WorldView Ltd., Omaha, Nebr., USA).

One desirable feature of the document corpus search and retrieval systems described in accordance with the present teachings is that they may be adapted to provide a wide variety of features relating to file formats that they can index, search specification, search result peculiarities, index file formats, and corpus storage. The document corpus database of the present teachings further offers the core functionality of rapid document indexing and retrieval.

In various embodiments, the document corpus database of the present teachings may be used to store large amounts of biological information from textual sources from research papers and/or textual identifiers, such as gene IDs or genetic bases. A unique feature of the present document corpus database is its ability to be adapted to numerically intensive data, such as gene-expression or other analysis data.

In various embodiments, the present teachings provide a system and methods for storing textual and numerically intensive data (such as biological data, gene expression data, sequence detection data (e.g., Sequence Detection System (SDS) analysis data; Applied Biosystems, Foster City, Calif., USA) and other types of data in a document corpus system for rapid retrieval and analysis. In various embodiments, certain benefits may be realized when applying a document corpus system for use with gene expression information and data and may offer significant advantages as compared to a conventional relational model or relational information management/query approach. For example, the document corpus system permits users accustomed to manipulating information in files to be able to do so while allowing retention of the original document and indexing its interesting properties for search.

In the context of analysis of biological data, for example gene expression data, it will be appreciated that this data is typically made up of many values that cover a small range. Some of these values may repeat often, especially as the size of the project increases. In a conventional relational database, data and values are typically not stored efficiently due partially to the duplication of values, and due partially to the necessity to maintain keys that define the relationships.

Conversely, a document corpus system may be adapted to store data and information results directly within a selected document, alleviating the need or requirement for use of referential keys. Furthermore, in a document corpus system duplicated keys may be stored together and compressed, saving storage space.

It will be appreciated that certain components of user-assigned labels within biological experiments may contain subcomponents of data that are meaningful principally to the researcher or the organization for whom the researcher works. For example a label such as “Mase_P06.14.01” may contain sample and date information (e.g., sample=Mase_P and date=6/14/2001). A document corpus search engines according to the present teachings may be designed to work with a selected language structure or labeling convention and may be configured to separate the information into one or more sub-components (i.e., “Mase”, “p06” and “14.01”) making each component a valid search target. In various aspects, biological data including gene expression queries may numerically qualify only a small subset of results from a large initial dataset, before performing qualitative analysis. The document corpus database of the present teachings may be adapted to perform searching of large datasets that can be easily qualified.

While certain conventional indexers may be adapted to support additional language models these systems are not targeted towards indexing of numeric data. To implement a document corpus for gene expression data it may be desirable to determine the correct granularity for indexing and in converting numeric observations into values that can be qualified by a document indexer such as Lucene (Apache Software Foundation, Forest Hill, Md., USA).

One such method for indexing principally numerical data based on the present teachings is described below. This method may be adapted for use with biological data converting for example principally numeric, analysis observations into values indexable by a conventionally available indexer such as Lucene. Additionally, other potentially significant factors are identified in the present teachings as applied to indexing of biological data such as sequence detection data and gene-expression documents (e.g., SDS and AB1700 gene-expression documents/information).

In one exemplary approach, a reverse-hash index is constructed from the initial dataset. In various embodiments, the dataset may comprise principally file-based information but such information may also be contained in a database. For example, for biological data related to gene expression results from a multi-well plate it may be the case that each well is represented by a document with respective analysis data as obtained from the instrument. In this data strings that represent interesting/desired search targets/candidates, such as probes, samples, and/or dyes (as well as other information) may be indexed using English parsing rules without stemming.

In an exemplary application, numerical values may be first translated into a string prior to indexing by converting the number into a selected base representation of the number (for example base-36). The representation of the numerical value may include any integer part and mantissa. The number may further be converted into an ordered tuple of a base representation exponent digit. For example, for a base-36 number the exponential digit may range from −9 to +9 and a mantissa value represented by a string of base-36 digits. The mantissa may then be assessed to determine if it is positive, in which case the exponent may be converted into a base-36 natural number by adding 18 to the exponent. If the mantissa is negative, the mantissa may be converted into a “twos-compliment” natural number by adding 35 to each negative digit of the mantissa. In this instance, the absolute value of this exponent may be retained as the leading digit.

Subsequently, the mantissa may be converted to a base 36 string using the following exemplary radix values based on extended hexadecimal notation: 0=0, 1=1, 2=2, 3=3, . . . , 10=A, 11=B, 12=C, . . . 33=X, 34=Y, 35=Z. Thereafter the leading digit may be converted into a base 36 string using the same radix values where the value may then be appended to the final mantissa string onto the leading digit producing a string.

It will be appreciated that the resulting string may share some properties with the original number that may be significant for document storage and searching of the gene-expression values. For example, string comparisons against the produced string, using the “C” locale, may have similar results as relational comparisons against the starting number. The resulting string also provides the advantage that it can be easily converted back into the source number for processing or presentation—eliminating the need to retrieve the numeric result from the source data.

Using the aforementioned method for transforming results while indexing biological data including gene expression data permits biological data (e.g. sequence detection data) to be stored and manipulated within a document storage system with relative ease. As previously described, a conventional document storage system, such as Lucerne, may be used for this purpose.

In evaluating the results of such an approach to data storage, one of skill in the art will appreciate that searching over a large set of data such as information relating to gene expression data across multiple wells or assays may prove to be significantly faster as compared to conventional relational database-based approaches. In some cases, document corpus queries may be processed twice as fast or more relative to a relational database query. Indexing of biological data in the manner described herein is also typically faster than relational database indexing and provides the further advantage of preserving linkages to source documents.

Another benefit provided by the present teachings is that this approach may eliminate some degree of dependency on relational databases for storage, processing or retrieval of analysis results. Eliminating this dependency distinguishes the technology from other conventional approaches for storage of gene expression data within relational databases (or relational/tabular storage structures). Furthermore, the system and methods of the present teachings offer potential competitive advantages in the field of biological data storage.

It will be appreciated that the reverse-hash indexing approach of the present teachings provides certain performance advantages to searching biological data. In one aspect, these performance advantages may be reflected in improved search times over a large corpus of data. Furthermore the reverse hash indexing methods provides the ability to define subtext for a particular domain. Additionally, the reverse hash indexing methods provide the ability to search subtext and assign rank to subtext results.

It will be appreciated by those of skill in the art that implementing storage solutions in a non-relational manner may convey certain benefits to the user. The exemplary embodiments shown and described herein are intended to illustrate relatively simplified configurations for highlighting the principles of storing large quantities of information including by way of example biological data. Skilled artisans would understand how to modify the data storage configurations based on the present teachings in order to achieve desired data organization, storage, query, and informational processing. It should therefore be understood that the data storage methods described above in conjunction with exemplary embodiments may be used with data and information of various configurations and including but not limited to biological data.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “less than 10” includes any and all subranges between (and including) the minimum value of zero and the maximum value of 10, that is, any and all subranges having a minimum value of equal to or greater than zero and a maximum value of equal to or less than 10, e.g., 1 to 5.

It is noted that, as used in this specification and the appended claims, the singular forms “a,” “an,” and “the” include plural referents unless expressly and unequivocally limited to one referent. Thus, for example, reference to “a layer” may include two or more different layers. As used herein, the term “include” and its grammatical variants are intended to be non-limiting, such that recitation of items in a list is not to the exclusion of other like items that can be substituted or added to the listed items.

Various embodiments of the teachings are described herein. The teachings are not limited to the specific embodiments described, but encompass equivalent features and methods as known to one of ordinary skill in the art. Other embodiments will be apparent to those skilled in the art from consideration of the present specification and practice of the teachings disclosed herein. It is intended that the present specification and examples be considered as exemplary only.

What is claimed is:

1. A method for processing gene expression data comprising:
converting a plurality of analysis observations into transformed values;
indexing the transformed values to form a reverse hash index; and
storing the reverse hash index in a document corpus database.

2. A method for processing gene expression data according to claim 1, wherein indexing the transformed values to form a reverse hash index includes storing like values together to reduce replication of data.

3. A method for processing gene expression data according to claim 1, wherein the plurality of analysis observations in the converting step includes at least one repeated value.

4. A method for processing gene expression data according to claim 1, wherein the plurality of analysis observations in the converting step includes at least one of a threshold cycle (Ct) and a probe/primer combination.

5. A method for processing gene expression data according to claim 1, wherein the plurality of analysis observations in the converting step includes data obtained from at least one of a textual source and instrumentation.

6. A method for processing gene expression data according to claim 1, wherein the plurality of analysis observations in the converting step is obtained from a biological analysis using one of a microarray, microplate, and micro fluidic card in which multiple discrete elements or values of data are present.

7. A method for processing gene expression data according to claim 1, wherein indexing the transformed values to form a reverse hash index includes indexing for a desired search target using English parsing rules without stemming.

8. A method for processing gene expression data according to claim 1, wherein indexing the transformed values to form a reverse hash index further includes translating each numerical value into a string prior to indexing.

9. A method for processing gene expression data according to claim 8, wherein translating each numerical value into a string prior to indexing includes converting each numerical value into a selected base representation having an integer and a mantissa.

10. A method for processing gene expression data according to claim 8, wherein the string in the translating step can be converted back into the source number.

11. A method for processing gene expression data according to claim 1, further comprising:
manipulating information in the document corpus database;
retaining an unaltered version of the document corpus database; and
indexing at least one property of interest.

12. A computer readable medium comprising computer-executable instructions for performing the method of claim 1.

13. A computer readable medium comprising a document corpus database produced according to the method of claim 1.

14. A method for searching gene expression data comprising:
querying a document corpus database using at least one search target, wherein the document corpus database is produced by a method comprising:
converting a plurality of analysis observations into transformed values;
indexing the transformed values to form a reverse hash index; and
storing the reverse hash index in the document corpus database; and;
identifying matches within the document corpus database to the search target.

15. A method for searching gene expression data according to claim 14, wherein the plurality of analysis observations in the converting step includes at least one repeated value.

16. A method for searching gene expression data according to claim 14, wherein the plurality of analysis observations in the converting step includes at least one subcomponent of the search target.

17. A method for searching gene expression data according to claim 16, wherein identifying matches within the document corpus database to the search target includes identifying the subcomponent of the search target.

18. A method for searching gene expression data according to claim 14, wherein the search target includes subtext for a particular domain in the reverse hash index.

19. A method for searching gene expression data according to claim 18, wherein identifying matches within the document corpus database to the search target further comprises:
searching the reverse hash index in the document corpus database using the subtext to determine a subtext search result; and
assigning a rank to the subtext search result.

20. A system for compiling and searching gene expression data comprising:
an interface for obtaining a plurality of analysis observations and for inputting a search query including a search target;
a processor including executable instructions for
converting the plurality of analysis observations into transformed values, indexing the transformed values to form a reverse hash index, and storing the reverse hash index in a document corpus database; and
searching the reverse hash index in the document corpus database with the search target;
and;
a storage device for storing the document corpus database;
